(19) United States
(12) Patent Application Publication
(10) Pub. No.: US 2022/0187953 A1
(43) Pub. Date: Jun. 16, 2022

(54) INK COMPONENT AND METHOD FOR FORMING INSULATION LAYER AND TOUCH PANEL

(71) Applicant: TPK Touch Solutions (Xiamen) Inc., Xiamen (TW)

(72) Inventors: Lung Pin Chen, Chiayi City (TW); Yi Lung Yang, Taoyuan City (TW); Wei Chou Chen, Taoyuan City (TW); Chun Hung Chu, Hsinchu City (TW)

(21) Appl. No.: 17/123,204

(22) Filed: Dec. 16, 2020

(51) Int. Cl. G06F 3/044; C09D 11/38; C09D 11/101; C09D 11/107

(52) U.S. Cl. CPC G06F 3/0446; C09D 11/38; G06F 2203/04103; C09D 11/107; G06F 2203/04111; C09D 11/101

(57) ABSTRACT

An ink component for forming an insulation layer includes an acrylic resin, an acrylate monomer, a fluoro-containing thiol compound, a silane coupling agent, a photoinitiator, and a solvent, where the ink component may be used in an ink-jet processing. The insulation layer, with a thickness of 2 μm formed of the ink component, has a break down voltage higher than 800 V and a dielectric constant between 2.0 to 4.0 under a frequency of 100 kHz.

### BACKGROUND

### Field of Disclosure

The present disclosure relates to an ink component and method for forming an insulation layer and a touch panel.

### Description of Related Art

An insulation layer provides necessary electrical isolation in an electronic device, and the insulation layer may be patterned to a suitable shape corresponding to the design of the electronic device. The patterning of the insulation layer includes multiple processes. For example, coating a material of the insulation layer on a substrate, exposing the insulation layer by a mask with a pattern, removing portions of the insulation layer by a developing process, and baking the patterned insulation layer under high-temperature to obtain the patterned insulation layer on the substrate.

### SUMMARY

The disclosure provides an ink component for forming an insulation layer including an acrylic resin, an acrylate monomer, a fluoro-containing thiol compound, a silane coupling agent, a photoinitiator, and a solvent, where the ink component may be used in an ink-jetting process.

The disclosure provides a method for forming an insulation layer, which includes ink-jetting an ink component on a substrate to form an ink layer, low-temperature curing the ink layer, and curing the ink layer with an ultraviolet (UV) light to form the insulation layer. The ink component includes an acrylic resin, an acrylate monomer, a fluoro-containing thiol compound, a silane coupling agent, a photoinitiator, and a solvent.

The disclosure provides an insulation layer formed by the method mentioned above. In some embodiments of the disclosure, the insulation layer has a thickness of 2 μm and a break down voltage higher than 800 V, and the insulation layer has a dielectric constant between 2.0 to 4.0 under a frequency of 100 kHz.

The disclosure provides a touch panel including the insulation layer mentioned above. In some embodiments of the disclosure, the touch panel includes a substrate, a plurality of first sensing electrodes disposed on the substrate along a first direction, a connecting electrode disposed on the substrate and electrically connecting the first sensing electrodes, a plurality of second sensing electrodes disposed on the substrate along a second direction different from the first direction, the insulation layer disposed on the connecting electrode, and a bridge wire disposed on the insulation layer. Vertical projections of the first sensing electrodes do not overlap with vertical projections of the second sensing electrodes, the bridge wire electrically connects the second sensing electrodes, and the insulation layer electrically isolates the first sensing electrodes from the second sensing electrodes.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a process flow diagram of forming an insulation layer according to some embodiments;

FIG. 2A to FIG. 2C are schematic cross-sectional views at various stages of the process flow diagram according to some embodiments;

FIG. 3 is a current-voltage diagram of the insulation layers according to different embodiments;

FIG. 4 is a top view of a touch panel according to some embodiments;

and

FIG. 5 is a cross-sectional view of the touch panel according to the reference section in FIG. 4.

### DETAILED DESCRIPTION

The following disclosure provides many different embodiments, or examples, for implementing different features of the provided subject matter. Specific examples of components, operations, materials, arrangements, etc., are described below to simplify the present disclosure. These are, of course, merely examples and are not intended to be limiting. Other components, operations, materials, arrangements, etc., are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Because of the component characteristic of the insulation layer solution in the insulation layer forming process nowadays, the insulation layer is patterned by first coating and curing the insulation layer on the substrate and then the developing process (for example, wet etching) with a mask and high-temperature baking (for example, temperature about 150° C. to 250° C.) is performed. In some embodiments, the pattern curing of the insulation layer further needs light irradiation (for example, by ultraviolet (UV) light). These developing processes include multiple operations of an etching process which is cost and time consuming. In addition, the high-temperature process is hard to be compatible with the flexible substrate, and this leads to more limitations on the entirety process.

The present disclosure provides an ink component for forming an insulation layer. The patterned insulation layer may be directly formed on the substrate by ink-jetting and cured by UV light without a mask. The insulation forming layer forming process provided by the disclosure simplifies the patterning steps and broadens the process application range since a low-temperature process may be applied on the flexible substrate.

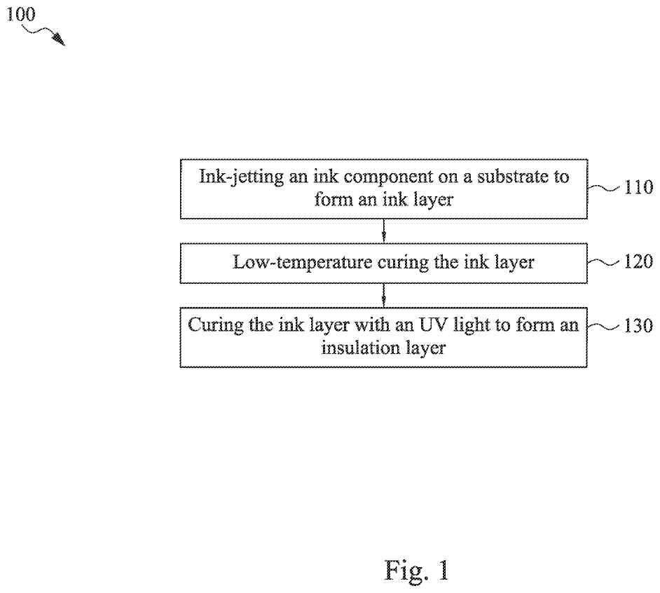

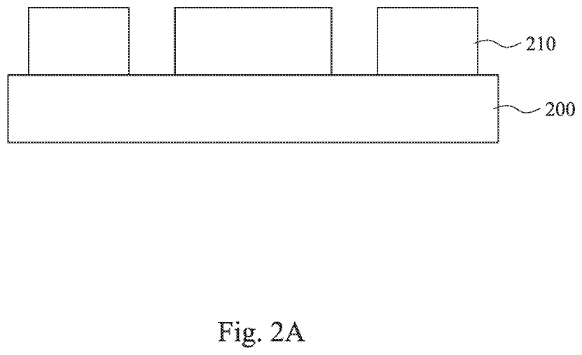

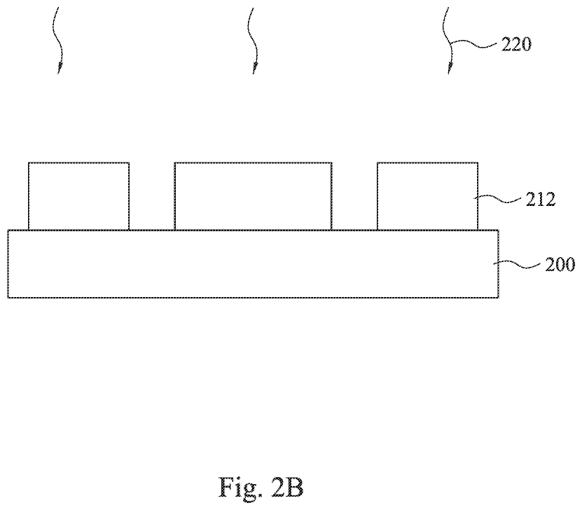

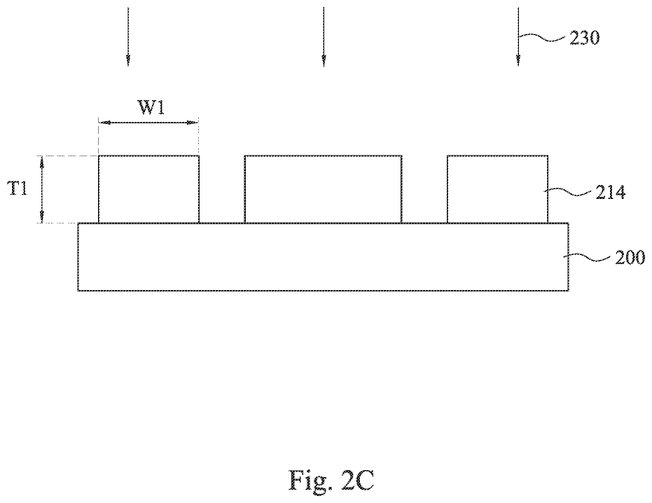

According to some embodiments of the present disclosure, FIG. 1 illustrates a process flow diagram 100 of forming the insulation layer, and FIG. 2A to FIG. 2C illustrate schematic cross-sectional views at various stages of the process flow diagram 100. FIG. 1 to FIG. 2C only illustrate an example process using the ink component provided by the disclosure. It should be acknowledged that the alternative embodiments with additional operations before, during, and after the process are also in the scope of the disclosure.

Referring to FIG. 1 and FIG. 2A, the ink component is coated on a substrate 200 to form an ink layer 210 by an ink-jetting process (also referred as a spray coating process). The corresponding process is illustrated as the operation 110 of the process flow diagram 100 in FIG. 1.

In some embodiments, as shown in FIG. 2A, the ink layer 210 may have a patterned shape after being formed on the substrate 200 by the ink-jetting process. For example, the ink-jetting process may be performed after covering some regions of the substrate 200 with a mask. Therefore, there is no need to perform additional developing processes for patterning in the following process. In other embodiments, the ink component may be ink-jetted on the entire surface of the substrate 200 and patterned in the following process (for example, dry etching or wet etching) to form the ink layer 210.

The substrate 200 may be applied in various electronic devices, for example a touch panel. In some embodiments, the substrate 200 may include the rigid substrate used in a high-temperature process, such as a glass substrate, a wafer, a quartz substrate, a silicon carbide substrate, a ceramic substrate, and the like.

In some embodiments, the substrate 200 may be a flexible substrate suitable for bendable devices. In some embodiments, the substrate 200 may include a flexible substrate used in a low-temperature process, such as polyethylene terephthalate (PET), cyclo olefin polymer (COP), cyclo olefin copolymer (COC), polycarbonate (PC), poly methyl methacrylate (PMMA), polyimide (PI), polyethylene naphthalate (PEN), polyvinylidene difluoride (PVDF), polydimethylsiloxane (PDMS), and the like.

The ink component forming the ink layer 210 includes an acrylic resin, an acrylate monomer, a fluoro-containing thiol compound, a silane coupling agent, a photoinitiator, and a solvent.

In some embodiments, the acrylic resin may include soluble acrylate copolymer, soluble epoxyacrylate resin, the like, or the combination thereof. In some embodiments, the percentage by weight of the acrylic resin in the ink component may be between 9 wt % to 33 wt % for forming the ink layer 210.

In some embodiments, the acrylate monomer may include dimethacrylate, triacrylate, pentaacrylate, hexaacrylate, the like, or the combination thereof. In some embodiments, the percentage by weight of the acrylate monomer in the ink component may be between 10 wt % to 30 wt % for forming the ink layer 210.

The acrylic resin has higher viscosity because of the characteristic of macromolecule compound. If the acrylic resin is used alone as the ink component, the viscosity of the ink component may be too high to be applied in the ink-jetting process. In contrast, the acrylate monomer has lower viscosity since it is a small molecule compound. If the acrylate monomer is used alone as the ink component, the viscosity of the ink component may be too low to maintain the film formation feature on the substrate 200 or to be ink-jetted into the patterned shape. In the embodiments of the disclosure, the ink component for forming the ink layer 210 is appropriately adjusted to obtain an ink component with suitable viscosity for being directly applied in the ink-jetting process.

More specifically, the ink component includes the acrylic resin with high viscosity and the acrylate monomer with low viscosity. The viscosity of the ink component under room temperature, such as 25° C., may be about 5 mPa·s to 40 mPa·s to be suitable for ink-jet printing devices by adjusting the ratio of the acrylic resin and the acrylate monomer. For example, adjusting the percentage by weight of the acrylic resin in the ink component to be about 9 wt % to 33 wt % and the percentage by weight of the acrylate monomer in the ink component to be about 10 wt % to 30 wt %. Therefore, the ink component may be applied in the ink-jetting process to directly form the ink layer 210 on the substrate 200. In some embodiments, a surface tension of the ink component for forming the ink layer 210 may be between about 20 dyne to 42 dyne.

The ink component for forming the ink layer 210 may include the photoinitiator. In the following UV light curing process with the irradiation of the UV light, the photoinitiator generates free radicals because of the irradiation. The free radicals initiate a polymerization reaction of the acrylic resin and the acrylate monomer to form the cured insulation layer. In some embodiments, the photoinitiator may include IRGACURE®184, IRGACURE®1173, IRGACURE®2959, IRGACURE®127, IRGACURE®907, IRGACURE®379, IRGACURE®754, IRGACURE®OXE01, IRGACURE®OXE02, IRGACURE®TOP, IRGACURE®819, IRGACURE®784, the like, or the combination thereof. In some embodiments, the percentage by weight of the photoinitiator in the ink component for forming the ink layer 210 may be between about 2 wt % to 7 wt %.

The ink component for forming the ink layer 210 may include the fluoro-containing thiol compound and the silane coupling agent that together provide synergism in the ink component, which leads to higher break down voltage and a lower dielectric constant of the ink layer 210 after the following curing process. This will be described in more details below.

In some embodiments, the fluoro-containing thiol compound may include fluoroalkylthiol, fluoroalkylthiophenol, the like, derivatives thereof, or the combination thereof. In some embodiments, the silane coupling agent may include 2-(3,4-epoxycyclohexyl)ethyltrimethoxysilane, N-(2-aminoethyl)-3-aminopropyltrimethoxysilane, 3-(methacryloxy)propyltrimethoxysilane, the like, or the combination thereof.

In some embodiments, the percentage by weight of the fluoro-containing thiol compound in the ink component may be between about 0.001 wt % to 0.1 wt %, and the percentage by weight of the silane coupling agent in the ink component may be between about 0.1 wt % to 1 wt % for forming the ink layer 210.

The ink component for forming the ink layer 210 may include the solvent in which the abovementioned compounds may be dissolved, such as water, ethanol, isopropanol, acetone, diacetone alcohol, tetrahydrofuran, aprotic solvent (for example, N-methylpyrrolidone, dimethylformamide, dimethyl sulfoxide), propylene glycol monomethyl ether acetate, propylene glycol monomethyl ether, 3-methoxy-1-butanol, ethyl acetate, cyclohexanone, cyclopentanone, the like, or the combination thereof. In some embodiments, the percentage by weight of the solvent in the ink component may be between about 29 wt % to 79 wt % for forming the ink layer 210.

Referring to FIG. 1 and FIG. 2B, a cured ink layer 212 is formed on the substrate 200 by a low-temperature curing process 220 (also referred as a first curing process). For example, the cured ink layer 212 may be formed by heating. The corresponding process is illustrated as the operation 120 of the process flow diagram 100 in FIG. 1. The ink layer 210 in FIG. 2A becomes the cured ink layer 212 on the substrate 200 through the low-temperature curing process 220.

The low-temperature curing process 220 is operated under a low temperature. In this way, the substrate 200 may not be distorted or damaged by a high temperature during the formation of the cured ink layer 212 such that the selectable types of the substrate 200 are increased to include, for example, the types of the substrate 200 mentioned above. In some embodiments, the temperature of the low-temperature curing process 220 may be lower than the highest process-temperature of the substrate 200. Generally, the highest process-temperature of the substrate 200 is roughly related to the glass transition temperature (Tg) of the substrate 200.

In some embodiments, the temperature of the low-temperature curing process 220 may be lower or equal to 130° C. In some embodiments, the temperature of the low-temperature curing process 220 may be between about 50° C. to 130° C. This range of the process-temperature is generally lower than the highest process-temperature of a plastic that may be used for the substrate 200 (for example, about 120° C. for the highest process-temperature of PET, about 130° C. for the highest process-temperature of PC, about 110° C. for the highest process-temperature of PMMA, etc.) used in the electronics industry. The abovementioned range of the process-temperature is also lower than the highest process-temperature of a high thermo-resistant material that may be used for the substrate 200 (for example, about 500° C. for the highest process-temperature of glass substrate and about 150° C. for the highest process-temperature of PEN). Therefore, the low-temperature curing process 220 may also be suitable for the abovementioned rigid substrate.

In some embodiments, the space or the chamber in which the substrate 200 is disposed is heated in the low-temperature curing process 220 to form the cured ink layer 212. In some embodiments, the substrate 200 is directly heated in the low-temperature curing process 220 to form the cured ink layer 212.

The cured ink layer 212, having a surface without adhesion, is attached on the substrate 200 after the low-temperature curing process 220, such that other operations may be applied or the cured ink layer 212 may be temporally stored before the following UV light curing process. This increases the adaptability of the manufacturing process. For example, in some embodiments in which the substrate 200 is a flexible substrate, the cured ink layer 212 on the substrate 200 may become a roll shape together with the flexible substrate 200 without damaging the patterned shape, so that the cured ink layer 212 and the substrate 200 may be stored together. The roll shaped substrate 200 and cured ink layer 212 may be provided later in a roll-to-roll process.

The ink component forming the ink layer 210 in FIG. 2A includes the fluoro-containing thiol compound and the silane coupling agent that provide synergism in the ink component, such that the cured ink layer 212 after the low-temperature curing process has the higher break down voltage and the lower dielectric constant. In some embodiments, the cured ink layer 212 with the abovementioned characteristics may be applied in the insulator in electronic elements (for example, the insulation layer between the electrodes), which improves the electrical isolation performance of the insulation layer.

Referring to FIG. 1 and FIG. 2C, an insulation layer 214 is formed on the substrate 200 by a UV light curing process (also referred as a second curing process). The corresponding process is illustrated as the operation 130 of the process flow diagram 100 on FIG. 1. Referring to FIG. 2C with FIG. 2B, the cured ink layer 212 is further cured by the UV light curing process to form the insulation layer 214 on the substrate 200.

In the UV light curing process, the cured ink layer 212 is irradiated by a UV light 230. As a result, the free radicals generated by the photoinitiator in the cured ink layer 212 catalyze the yield of the acrylic polymer from the acrylic resin and the acrylate monomer, thereby forming the insulation layer 214. In some embodiments, the energy of the UV light 230 may be between about 50 mJ/cm² to 6000 mJ/cm².

The insulation layer 214 after curing by the UV light 230 includes the acrylic polymer, the fluoro-containing thiol compound, and the silane coupling agent. As shown in FIG. 2C, the insulation layer 214 after the UV light curing process has a thickness T1 and a width W1. In some embodiments, the thickness T1 may be in a range of 1 μm to 15 μm. More specifically, the thickness T1 may be in a range of 2 μm to 12 μm. The width W1 may correspond to the resolution of the ink-jetting process so that the insulation layer may be more suitable in a large size device such as a television screen. In some embodiments, the width W1 may be larger than or equal to 40 μm.

The dimension of the insulation layer 214 after the UV light curing process is slightly smaller than that of the cured ink layer 212 before the UV light curing process. The difference of the dimension before and after the UV curing may be presented by the dimensional shrinkage, and smaller dimensional shrinkage indicates smaller deformation. On the other hand, the electrical characteristics (for example, the abovementioned break down voltage, the dielectric constant, or the like) of the insulation layer 214 are the same as those of the cured ink layer 212. That is, the second curing (referred as the UV light curing process) merely slightly increases the polymerization performance and changes the exterior dimension of the cured ink layer 212 without affecting the electrical characteristics of the cured ink layer 212. In some embodiments, the dimensional shrinkage may be less than 10% when comparing the insulation layer 214 after the UV light curing process with the cured ink layer 212.

In some embodiments, the low-temperature curing process (referred as the first curing or also referred to as a thermo-curing process) and the UV light curing process (referred as the second curing) may be performed simultaneously. The electrical characteristics of the resulting insulation layer 214 are similar to the abovementioned embodiments, and the dimensional shrinkage of the insulation layer 214 indicates the dimension difference between the ink layer after the film formation by ink-jetting (also referred as a wet film, similar to the ink layer 210 in FIG. 2A) and the cured insulation layer 214. In these embodiments, the dimensional shrinkage of the insulation layer 214 is similar to the abovementioned shrinkage, for example, less than 10%.

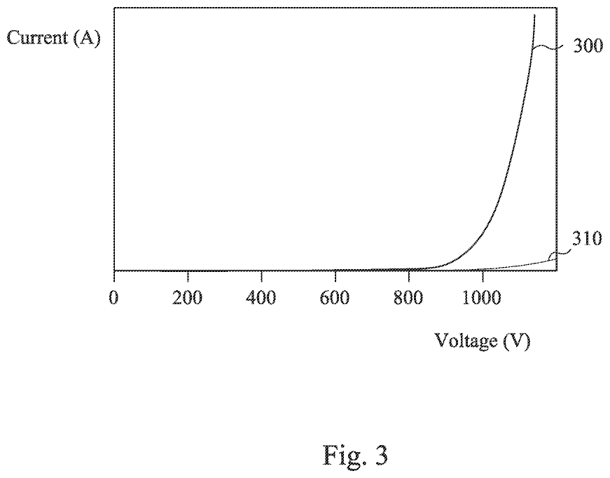

According to some embodiments, FIG. 3 illustrates a current-voltage diagram of the insulation layers in different embodiments to depict the break voltages of the insulation layer in those embodiments. In the current-voltage diagram, the current would rapidly increase when the voltage is increased to a threshold. The threshold of the voltage is then referred as the break down voltage.

Please refer to FIG. 3 and Table 1 below. In the comparison example 1 represented by line 300, the ink component forming the insulation layer is similar to that of the ink component forming the ink layer 210 in FIG. 2A except that the fluoro-containing thiol compound and the silane coupling agent are not included in the ink component. In the embodiment 1 represented by line 310, the ink component forming the insulation layer is the same as that of the ink component forming the ink layer 210. In some embodiments, the ink component of the comparison example 1 needs higher curing temperature, which would not satisfy the low-temperature process requirement of plastic substrates.

As shown in FIG. 3, line 300 starts rising at a voltage of about 800V, and line 310 starts rising at a voltage of about 1000V. In the embodiment 1, represented by line 310 and as shown in Table 1, the insulation layer with a thickness about 1.88 μm has a break down voltage about 938V, and the insulation layer under a frequency about 100 kHz has a dielectric constant about 2.94. It should be acknowledged that the thickness of the embodiment 1 is merely an example, and that other thicknesses (for example, between 2 μm to 12 μm) may be included in different embodiments. The insulation layer in the embodiment 1 includes the fluoro-containing thiol compound and the silane coupling agent, which increases the break down voltage and decreases the dielectric constant of the insulation layer.

TABLE 1

| | Comparison | |
|---|---|---|
| Ink Component | Example 1 | Embodiment 1 |
| Acrylic resin | 10% | 16% |
| Acrylate monomer | 20% | 20% |
| Fluoro-containing thiol | NA | 0.01% |
| compound | | |
| Silane coupling agent | NA | 0.5% |
| Photoinitiator | 5% | 5% |
| Solvent | 65% | 58.49% |
| Break down | 838 V | 938 V |
| voltage(@1.88 μm) | | |
| Dielectric constant | 4.46 | 2.94 |
| (@100 kHz) | | |

The break down voltage suggests the electrical insulation performance of the insulation layer. The higher break down voltage of the insulation layer leads to the higher electrical insulation effect while the thicker insulation layer has the higher break down voltage. In addition to the break down voltage, the electrical insulation performance is also usually presented by the dielectric constant. The smaller dielectric constant of the insulation layer leads to the higher electrical insulation effect. In some embodiments, the insulation layer with a thickness about 2 μm (the insulation layer thickness 1.88 μm listed in Table 1 may be considered as the insulation layer with the thickness about 2 μm mentioned in the description because of the process tolerance, the measurement deviation, or the like) has a break down voltage higher than about 800 V, such as larger than 850V, 900V, 950V, or 1000V. The insulation layer also has a dielectric constant in a range of about 2.0 to 5.0 under a frequency of 100 kHz, more specifically, in a range of about 2.0 to 4.0 (for example, about 2.5, 3.0, or 3.5).

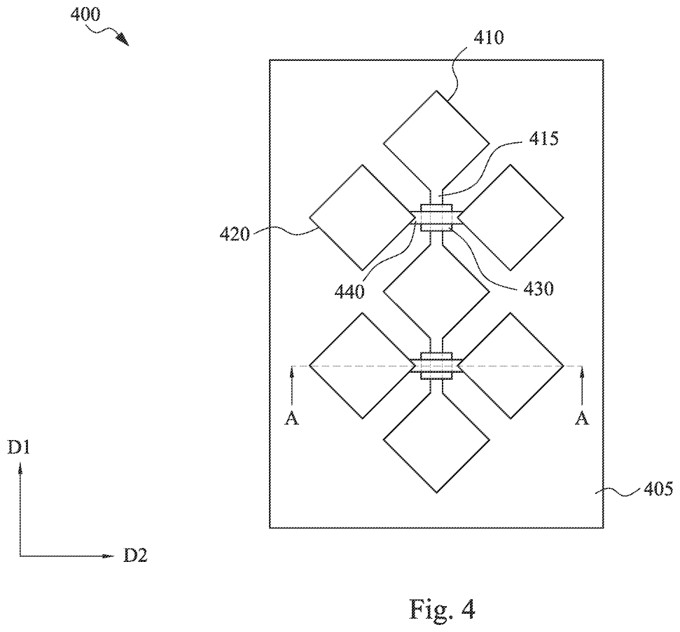

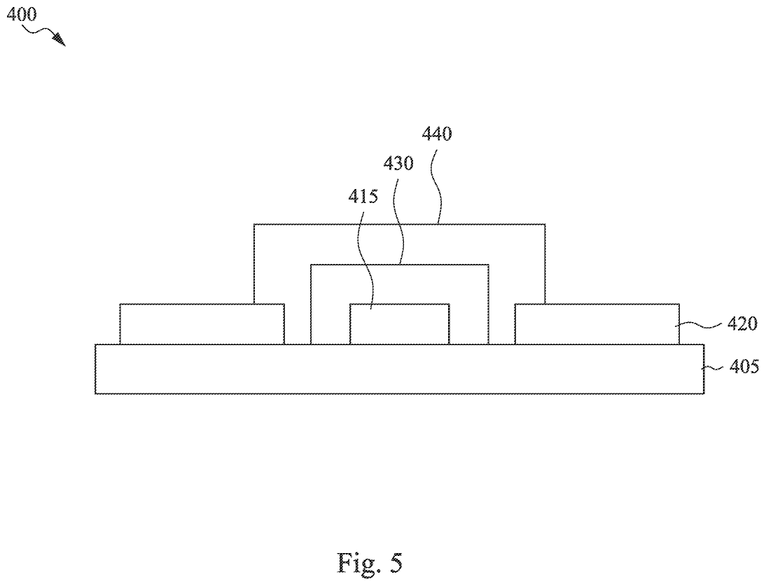

According to some embodiments, FIG. 4 illustrates a top view of a touch panel 400 in which an insulation layer 430 is formed by the ink-jetting (spray coating) process with the ink component of the present disclosure. FIG. 5 illustrates the cross-sectional view of the touch panel 400 at line A-A in FIG. 4.

Referring to FIG. 4 and FIG. 5, the touch panel 400 is a single-side bridge touch panel. In some embodiments, “single-side” refers to a transparent conductive layer, such as indium tin oxide (ITO), metal nanowire layer, or the like, formed on one side of the substrate. In some embodiments, the touch panel 400 may include a substrate 405, first sensing electrodes 410, a connecting electrode 415, second sensing electrodes 420, the insulation layer 430, and a bridge wire 440. However, it should be acknowledged that alternative embodiments of the touch panel 400 with additional components are also in the scope of the disclosure.

The substrate 405 may include a flexible substrate similar to the substrate 200 in FIG. 2A or a rigid substrate. The material forming the first sensing electrodes 410, the connecting electrode 415, the second sensing electrodes 420, and the bridge wire 440 may include ITO, metal mesh, metal nanowire, graphite, or other transparent conductors. The material forming the insulation layer 430 includes the ink component provided by the present disclosure.

The “metal nanowire” used herein is a collective term, which refers to a collection of metal wires including multiple elemental metals, metal alloys, or metal compounds (including metal oxides). The number of the metal nanowires does not affect the scope of the disclosure. At least one cross-sectional dimension (that is, the diameter of the cross-section) of a metal nanowire is smaller than about 500 nm, preferably smaller than about 100 nm, and more preferably smaller than about 50 nm. The metal nanostructures referred to as “wire” herein mainly have a high aspect ratio, for example, between about 10 and 100,000. More specifically, the aspect ratio (length:diameter of the cross-section) may be greater than about 10, preferably greater than about 50, and more preferably greater than about 100. The metal nanowire may be any metal including, but not limited to, silver, gold, copper, nickel, and gold-plated silver. Other terms, such as silk, fiber, tube, or the like, also having the abovementioned dimension and high aspect ratio are also within the scope of the disclosure.

The metal nanowire layer may include a silver nanowire layer, a gold nanowire layer, or a copper nanowire layer. In some embodiments, a dispersion solution or an ink with metal nanowires is coated on the substrate 405 and dried so that the metal nanowires cover the surface of the substrate 405 to form the metal nanowire layer. After the abovementioned drying (curing) operation, the solvent and other substances in the ink are volatilized, and the metal nanowires are distributed in a random manner on the surface of the substrate 405. The metal nanowires may contact each other to provide a continuous current path, thereby forming a conductive network. The metal nanowire layer is further patterned to form a sensing circuit (for example, the first sensing electrodes 410, the connecting electrode 415, the second sensing electrodes 420, or the like).

In other embodiments, a film layer may be coated to form a composite structure with the metal nanowire layer. The composite structure may have certain specific chemical, mechanical, and optical properties, for example, providing adhesion between the metal nanowires and the substrate 405, or providing higher physical mechanical strength. Therefore, the film layer may also be referred as a matrix. In other embodiments, some specific polymers may be used to form the film layer, so that the metal nanowires have additional surface protection against scratches and abrasion. In these cases, the film layer may also be referred as a hard coat or an overcoat. Materials such as polyacrylate, epoxy resin, polyurethane, polysilane, polysiloxane, poly(silicon-acrylic acid), or the like may lead to higher surface strength of the metal nanowires to improve the scratch resistance. In addition, a UV stabilizer may be added into the film layer to improve the UV light resistance of the metal nanowires. However, the abovementioned embodiments are merely possibilities of additional functions or names of the film layer and are not intended to limit the present disclosure.

The first sensing electrodes 410 formed on the substrate 405 may include any possible shape and may be arranged along a first direction D1. Adjacent first sensing electrodes 410 are electrically connected by the connecting electrode 415. The second sensing electrodes 420 formed on the substrate 405 may include any possible shape and may be arranged along a second direction D2. As shown in FIG. 4, the first sensing electrodes 410 and the second sensing electrodes 420 are arranged in a staggered manner in the top view, and vertical projections of the first sensing electrodes 410 do not overlap with vertical projections of the second sensing electrodes 420.

The insulation layer 430 is then formed on the connecting electrode 415. The insulation layer 430 may be formed by the method and the ink component for forming the insulation layer provided by the present disclosure. That is, the patterned insulation layer 430 may be formed by the low-temperature ink-jetting process. The low temperature in the manufacturing process and the patterning process without etching of the insulation layer 430 avoid damaging the pre-formed substrate 405, first sensing electrodes 410, and second sensing electrodes 420.

The thickness of the insulation layer 430 may be appropriately adjusted corresponding to the process and/or materials of the first sensing electrodes 410 and the second sensing electrodes 420. In some embodiments, the first sensing electrodes 410 and the second sensing electrodes 420 are formed of ITO materials, and the thickness of the insulation layer 430 may be about 2 μm. In other embodiments, the first sensing electrodes 410 and the second sensing electrodes 420 are formed of silver nanowire materials, and the thickness of the insulation layer 430 may be about 6 μm.

The bridge wire 440 is formed on the insulation layer 430 and electrically connects adjacent second sensing electrodes 420. The insulation layer 430 with the abovementioned break down voltage and dielectric constant is located between the connecting electrode 415 and the bridge wire 440. Therefore, the insulation layer 430 is able to electrically isolate the first sensing electrodes 410 and the second sensing electrodes 420.

The present disclosure provides a method for forming an insulation layer. The patterned insulation layer is directly formed by a low-temperature ink-jetting process, which prevents the material restriction or damage of other components in the device caused by high temperature, developing, or etching. The ink component forming the insulation layer includes the acrylic resin and the acrylate monomer such that the ink component is suitable for use in the ink-jetting equipment. The ink component forming the insulation layer also includes the fluoro-containing thiol compound and the silane coupling agent, which leads to the increasing of the break down voltage and the decreasing of the dielectric constant of the insulation layer.

The method for forming an insulation layer provided by the present disclosure may be applied in various electronic device manufacturing processes, such as the ink component to form the touch panel, a flexible screen, a large dimension device, or the like.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An ink component for forming an insulation layer, comprising:
an acrylic resin;
an acrylate monomer;
a fluoro-containing thiol compound;
a silane coupling agent;
a photoinitiator; and
a solvent, wherein the ink component is used in an ink-jetting process.

2. The ink component of claim 1, wherein a viscosity of the ink component at 25° C. is 5 mPa·s to 40 mPa·s.

3. The ink component of claim 1, wherein a percentage by weight of the acrylic resin is 9 wt % to 33 wt %, and a percentage by weight of the acrylate monomer is 10 wt % to 30 wt %.

4. The ink component of claim 1, wherein a percentage by weight of the fluoro-containing thiol compound is about 0.001 wt % to 0.1 wt %, and a percentage by weight of the silane coupling agent is about 0.1 wt % to 1 wt %.

5. A method for forming an insulation layer, comprising:
ink-jetting an ink component on a substrate to form an ink layer, wherein the ink component comprises:
an acrylic resin;
an acrylate monomer;
a fluoro-containing thiol compound;
a silane coupling agent;
a photoinitiator; and
a solvent;
low-temperature curing the ink layer; and
curing the ink layer with an ultraviolet (UV) light to form the insulation layer.

6. The method of claim 5, wherein a temperature of the low-temperature curing is 50° C. to 130° C.

7. The method of claim 5, wherein a dimensional shrinkage between the ink layer and the insulation layer is less than 10%.

8. The insulation layer formed by the method of claim 5.

9. The insulation layer of claim 8, wherein the insulation layer has a thickness of 2 μm and a break down voltage higher than 800 V.

10. The insulation layer of claim 8, wherein the insulation layer has a dielectric constant between 2.0 to 4.0 under a frequency of 100 kHz.

11. The insulation layer of claim 8, wherein a thickness of the insulation layer is 2 μm to 12 μm.

12. A touch panel comprising the insulation layer of claim 8.

13. The touch panel of claim 12, comprising:
a substrate;
a plurality of first sensing electrodes disposed on the substrate along a first direction;
a connecting electrode disposed on the substrate and electrically connecting the first sensing electrodes;
a plurality of second sensing electrodes disposed on the substrate along a second direction different from the first direction, wherein vertical projections of the first sensing electrodes do not overlap with vertical projections of the second sensing electrodes;
the insulation layer disposed on the connecting electrode; and
a bridge wire disposed on the insulation layer, wherein the bridge wire electrically connects the second sensing electrodes, and the insulation layer electrically isolates the first sensing electrodes from the second sensing electrodes.

14. The touch panel of claim 13, wherein the first sensing electrodes, the connecting electrode, and the second sensing electrodes comprise silver nanowire layers.
